(19) United States
(12) Patent Application Publication
(10) Pub. No.: US 2021/0213543 A1
(43) Pub. Date: Jul. 15, 2021

(54) DRILL TIP AND METHOD FOR PRODUCING A DRILL TIP

(71) Applicant: Kennametal Inc., Latrobe, PA (US)

(72) Inventors: Herbert Rudolf Kauper, Erlangen (DE); Jürgen Schwägerl, Vohenstrauss (DE); Christian Strauchmann, Eggolsheim (DE); Julia Tempelmeier, Hilpoltstein (DE)

(21) Appl. No.: 17/267,992

(22) PCT Filed: Jul. 18, 2019
(86) PCT No.: PCT/EP2019/069320

§ 371 Date: Feb. 11, 2021

(30) Foreign Application Priority Data
Aug. 13, 2018 (DE) 10 2018 213 630.0
Feb. 21, 2019 (DE) 10 2019 202 396.7

(51) Int. Cl. B23B 51/02

(52) U.S. Cl. CPC B23B 51/02; B23B 2251/18; B23B 2251/14; B23B 2251/04

(57) ABSTRACT

The invention relates to a drill tip (2), comprising a center (4), at which a chisel edge (6) is arranged, and comprising a main cutting edge (8), which adjoins the chisel edge (6) and runs outward from the center (4). A rake angle is formed along the chisel edge (6) and the main cutting edge (8). The main cutting edge (8) has an inner portion (10), which adjoins the chisel edge (6) and is arranged within the center (4). The main cutting edge (8) has an outer portion (12), which outwardly adjoins the inner portion (10) and is arranged outside of the center (4). A point thinning (16) is formed on the drill tip (2), which point thinning is curved in such a way that the inner portion (10) runs arcuately from an outer edge of the center (4) toward the chisel edge (6). The invention further relates to a method for producing a drill tip (2) of this type.

### BACKGROUND OF THE INVENTION

The invention relates to a drill tip and a method for producing a drill tip.

A drill is a rotary tool for machining a workpiece. On the front side, a drill has a drill tip which comprises a number of cutting edges for machining material. When the drill rotates in a direction of rotation, the cutting edges remove chips from the workpiece, which are then usually transported away via flutes in the drill. In the center, a drill typically has a chisel edge which is adjoined to the outside by a plurality of main cutting edges. The chisel edge itself does not usually have a chip-removing effect, but serves merely to displace material from the center.

Particularly important for a drill is the so-called centering, which indicates how much a drill is affected by lateral forces and deviates from ideal rotation around the axis of rotation during operation. Inadequate centering sometimes causes the drill to deviate sideways in an uncontrolled manner during operation and consequently experience increased mechanical stress. The service life of the drill is thus disadvantageously reduced. The centering is largely dependent on the specific design of the cutting edges and particularly on the size of the chisel edge, which, as described, does not contribute to the cutting performance.

The chip formation behavior of the drill is important as well. For example, the formation of many small chips can be distinguished from the formation of only one long chip on a respective cutting edge. The chip formation behavior is likewise strongly affected by the specific design of the cutting edges.

DE 10 2013 201 062 A1 describes a drill tip having a specific point thinning, which extends in a principle direction and transitions convexly from a free surface into a flute. Particularly efficient thinning and a large clearance angle can consequently be achieved in the region of the chisel edge.

### OBJECT OF THE INVENTION

With this in mind, the object of the invention is to improve the centering of a drill. The best possible chip formation behavior should also be ensured at the same time.

### Achieving the Object

The object is achieved according to the invention by a drill trip having the features according to claim 1 and by a method for producing a corresponding drill tip having the features according to claim 20. Advantageous configurations, further developments, and variants are the subject matter of the subclaims. The statements made in connection with the drill tip also apply accordingly to the method and vice versa.

The drill tip is in particular a part of a drill. In a first design, the drill tip is an integral component of the drill and as such is monolithically connected to a shank. In a second design, the drill tip is a separate part and is then configured as an insert that can be inserted into a carrier, so that the carrier and the drill tip together form a modular drill. During operation, the drill tip rotates around an axis of rotation, which is also an axis of rotation of the drill as a whole and which also corresponds to a longitudinal axis of the drill tip. During operation, the drill tip rotates in one direction of rotation.

The drill tip comprises a center in which a chisel edge is disposed. Therefore, when viewing the drill tip from the front along the axis of rotation, the center is located in the middle and also includes the axis of rotation. The drill, and specifically the drill tip, in particular comprises a number of flutes, which define the center as the region located centrally between the flutes. The center is usually circular and has a radius that corresponds to a radius of the drill tip or the drill as a whole minus a flute depth. The center is also referred to as the core.

The drill tip further comprises a main cutting edge, which adjoins the chisel edge and extends outward from the center. The drill tip in particular comprises a plurality of, i.e. at least two main cutting edges, which respectively extend outward from the chisel edge. In the following, it is assumed without loss of generality that the drill tip has exactly two main cutting edges. However, designs having a different number of main cutting edges, and in principle also having only one main cutting edge, are possible and suitable as well. The main cutting edges and the chisel edge together form a cutting geometry of the drill tip. The main cutting edges and the chisel edge are respectively also referred to in short simply as the cutting edge.

Each of the cutting edges is adjoined by a surface which points in the direction of rotation and via which any produced chips are removed. The orientation of this surface relative to the workpiece is characterized by the so-called rake angle. The rake angle in particular determines the cutting performance of the respective cutting edge. A rake angle is thus configured along the chisel edge and the main cutting edge, which can in principle also assume different values at different locations along the cutting edges, depending on the design of the cutting edges.

The main cutting edge in the present case is divided into two portions. In other words: the main cutting edge comprises an inner portion which here adjoins the chisel edge and is disposed inside the center, and the main cutting edge further comprises an outer portion which adjoins the inner portion to the outside and is disposed outside the center. The transition from the inner portion to the outer portion thus also defines or marks the center of the drill tip, so that the inner portion is on the inside and the outer portion is on the outside. This is in particular the result of the inner portion being produced during manufacturing by a point thinning, by means of which material is removed in the center so that the chisel edge is shortened and the main cutting edge is lengthened and guided into the center. The outer portion extends outward, in particular to an outer surface of the drill tip.

The drill tip further comprises a point thinning, i.e. a point thinning is configured on the drill tip. The point thinning is disposed in the center. The point thinning is used to shorten the chisel edge, i.e. is ground in on the front during production to shorten the chisel edge. In doing so, the main cutting edge is correspondingly lengthened. The point thinning here is furthermore curved in such a way that the inner portion extends arcuately from an outer edge of the center toward the chisel edge. The point thinning is therefore a curved point thinning. The curved point thinning thus comprises a first curvature, which is in particular configured such that the point thinning curves axially and is therefore also referred to as an axial curvature. The point thinning consequently curves in particular around an axis which extends parallel to the axis of rotation or corresponds to it. The point thinning is therefore, as it were, curved in the direction of rotation. This is in contrast to the concave point thinning in DE 10 2013 201 062 A1 mentioned at the beginning, in which the point thinning curves radially, i.e. is curved around an axis perpendicular to the axis of rotation. The first curvature, and with it also the point thinning, generally has a first radius of curvature, which in particular indicates the radius with which the point thinning is preferably curved in the direction of rotation. In one suitable configuration, the first radius of curvature corresponds to a radius of the inner portion. The first radius of curvature is expediently between 5% and 40% of a diameter of the drill tip. The first radius of curvature is either constant or varies along the curvature.

The described curvature of the point thinning automatically results in an arcuate course of the main cutting edge in the center, so that the inner portion is also formed when the point thinning is formed. A significant advantage is now in particular that the arcuate course of the main cutting edge allows said main cutting edge to be taken particularly far into the center and the chisel edge to correspondingly be shortened significantly. This produces an advantageously particularly short chisel edge, as a result of which the drill tip has particularly good centering. The risk of breaking away laterally during operation is significantly reduced. As a result, the overall service life of the drill tip is advantageously increased. The correspondingly lengthened main cutting edge also results in a cutting effect far into the center, so that, during operation, a single particularly long and advantageously helical chip is advantageously produced instead of a multitude of short chips. In other words: the particularly long main cutting edge and its arcuate configuration in the center significantly improve the chip formation behavior in the center. This also contributes to a more stable concentricity of the drill tip and thus to improved centering. Overall, therefore, the arcuate main cutting edge and the advantageously shortened chisel edge result in a particularly stable center. The point thinning also provides an additional chip space in which chips are held during operation.

The point thinning is in particular configured as an uninterrupted and continuous surface, i.e. does not itself contain any discontinuous transitions or edges or steps, but is overall smooth. However, as a transition to adjacent other surfaces such as a flute or a free surface, for example, edges are in principle possible.

A flute is in particular configured in a leading position, i.e. in the direction of rotation in front of the main cutting edge. Said flute therefore adjoins the main cutting edge, more specifically the outer portion, whereas the point thinning adjoins the inner portion, which ultimately guides a chip into the flute. The flute is used to convey a chip that is removed by the main cutting edge. The flute is usually spiral-shaped and extends from the front to the rear, so that a chip is accordingly conveyed in axial direction to the rear. A free surface is in particular configured on the other side of the main cutting edge, i.e. opposite to the flute, i.e. in the direction of rotation behind the main cutting edge and trailing it during operation. The free surface generally faces forward toward the workpiece. The free surface forms a clearance angle with a workpiece or an imaginary plane perpendicular to the axis of rotation. For each main cutting edge of the drill tip, a respective flute and free surface are preferably configured, which surround the main cutting edge accordingly.

The inner portion as a whole extends in an arcuate manner, i.e. the inner portion follows an arcuate course. In principle, two variants are possible and advantageous. In a first variant, the inner portion is continuously arcuate, whereas in a second variant it is not continuous, but rather kinked in an arcuate manner. The point thinning is then accordingly continuous or kinked in a curved manner. The two variants can in principle be combined with one another in such a way that a first part of the inner portion is continuously arcuate and a second part of the inner portion is kinked in an arcuate manner.

According to the first variant of the inner portion, the inner portion in a preferred configuration is thus continuously arcuate and extends from the outer edge to the chisel edge in a continuously arcuate manner. Consequently, the entire inner portion forms a single, continuous arc having no discontinuities or kinking, and also no straight sections. At each position along the inner portion, said portion therefore has a specific radius of curvature, which does not necessarily have to be the same at each position. The radius of curvature preferably increases, i.e. becomes larger, from the inside to the outside. The same applies for the grinding path of the grinding wheel when configuring the point thinning and also for the axial curvature.

In the context of the second variant for the inner portion, a configuration is preferred in which the inner portion is kinked in an arcuate manner, and for this purpose comprises a plurality of straight subsections which are disposed at an angle to one another. The same applies for the curved grinding path of the grinding wheel when configuring the point thinning. Particularly preferred is a configuration in which the inner portion comprises exactly three straight subsections. The subsections are thus disposed roughly along an arc, which results in an overall arcuate course. In contrast to the continuously arcuate variant, the inner portion in the kinked arcuate variant comprises at least two straight subsections, which are disposed at an angle to one another and thereby form an arc. Viewed in the direction toward the free surface, two consecutive subsections then enclose an angle that is smaller than 180° and is preferably in the range of 100° to 175°. More than two subsections correspondingly form at least two angles, whereby in one suitable configuration a further inward angle is larger than a further outward angle. As a result, analogous to the outwardly increasing radius of curvature of the continuously arcuate variant, an inwardly increasing curvature is realized as well. Conversely, however, a configuration in which a further inward angle is smaller than a further outward angle is suitable too.

Two consecutive straight subsections are preferably connected to one another via a rounded corner such that a continuously arcuate transition is formed between two subsections. Three straight subsections are then correspondingly connected to one another via two rounded corners. A respective rounded corner is preferably configured with a radius of curvature in the range of 0.05 mm to 3 mm. The rounded corners are in particular shorter than the straight subsections.

In the case of a straight main cutting edge, the outermost subsection preferably transitions straight into the outer portion of the main cutting edge, so that there is no kink at the transition from the inner to the outer portion and the outer portion is continued through the outer portion into the center without interruption, so to speak, until the next subsection adjoins at an angle, optionally via a rounded corner.

Each straight subsection has a respective length. In a fundamentally suitable configuration, all of the subsections have the same length. However, a preferred configuration is one in which the length increases from the inside to the outside, so that a further outward subsection is longer than a further inward subsection. In the case of subsections having different lengths, the longest subsection is preferably at most ten times as long as the shortest subsection.

At least two main cutting edges are expediently formed, each comprising an arcuate inner portion, wherein the two inner portions are S-shaped when viewed together. Therefore, all of the main cutting edges of the drill tip are preferably further developed in the manner described above by using a respective curved point thinning. The resulting inner portions are then all curved in the same direction and together extend toward the chisel edge. The arcuate inner portions of two main cutting edges then form an S-shaped course, in the center of which the chisel edge is disposed.

The chisel edge is preferably likewise S-shaped. In one suitable configuration, the chisel edge is bordered by a plurality of, in particular twisted, free surfaces, which are configured such that the chisel edge accordingly extends in an S-shaped manner. Centering and chip formation behavior are further improved by this specific shape. Compared to a straight course, the free surfaces on both sides of the chisel edge have an enlarged surface in the S-shaped course, so that friction is reduced and the risk of breaking away laterally during operation is reduced as well. A respective free surface adjoins the rear of a respective main cutting edge in the direction of rotation, the free surface thus follows the respective main cutting edge during operation.

The free surface is generally bounded to the front by a main cutting edge. To the rear, the free surface is in particular bounded by a flute, which thus follows the free surface during operation. To the outside, the free surface is in particular bounded by an outer surface of the drill tip. In the center, on the other hand, the free surface is bounded by the chisel edge. The free surface is now preferably twisted such that an S-shaped chisel edge results. The chisel edge is preferably bounded laterally only by the free surfaces, i.e. the chisel edge is not bounded by the point thinning. In fact, only the end points of the chisel edge abut a respective point thinning, so that the chisel edge extends between two opposite point thinnings. The end points are in particular also transition points, at which a main cutting edge adjoins the chisel edge. In the case of a drill tip having two main cutting edges, therefore, four surfaces meet one another in the center; namely two free surfaces which laterally enclose the chisel edge, and two point thinnings which are spaced apart from one another by the chisel edge.

The drill tip is in particular configured such that the main cutting edge is subdivided in the front into the inner portion and the outer portion by the point thinning, and in the rear in particular only adjoins a free surface. In other words: the main cutting edge is adjoined in the rear by a free surface, the inner portion is adjoined in the front by the point thinning and the outer portion is adjoined in the front by a flute.

In one advantageous configuration, the point thinning connects a flute and a free surface and is additionally convex such that the point thinning extends from the flute in the direction of the free surface in an outwardly curved manner. The point thinning is therefore curved. The point thinning therefore has a second curvature. The point thinning connects the flute of one of the main cutting edges to the free surface of the corresponding leading main cutting edge. The convex point thinning is preferably configured as described in the aforementioned DE 10 2013 201 062 A1. The resulting complex course of the point thinning is correspondingly expensive to produce, but it provides significant advantages in terms of centering and chip formation behavior of the drill tip. In addition to being axially curved, the point thinning is also radially curved; i.e. in addition to the first curvature it has a second curvature, which is then a radial curvature and is also referred to as a radial curvature. This second curvature is in particular continuous and not kinked. The second curvature and correspondingly also the point thinning thus have a second radius of curvature, which in particular indicates the radius with which the point thinning is curved. The second radius of curvature in particular indicates the radius with which the point thinning transitions from the flute into the free surface; i.e. in particular the radius with which the point thinning is curved around a radial direction, wherein the radial direction is perpendicular to the longitudinal axis. In one suitable configuration, the second radius of curvature is between 5% and 60% of a diameter of the drill tip.

Alternatively or additionally, in one suitable configuration, the point thinning comprises a base which is concave and, viewed in longitudinal direction, in particular undercuts the inner portion. The point thinning therefore has a third curvature. The concave base is preferably created during the production of the drill tip using a convex, i.e. outwardly curved, grinding wheel. Such a grinding wheel has a grinding surface which faces radially outward with respect to an axis of rotation of the grinding wheel and is convex in cross-section perpendicular to the axis of rotation, in particular in the manner of a tire. The point thinning is then curved inward so to speak; i.e. in the direction of a rear side of the drill tip and into said drill tip. Viewed in a cross-section to the longitudinal axis, the point thinning thus forms a recess. The recess in particular also results in a cross-section perpendicular to the second curvature. The convex point thinning with the concave base thus has a saddle-shaped course and is therefore configured as a saddle surface between the flute and the free surface. Due to the first curvature, the saddle surface is also curved in the direction of rotation. The third curvature of the point thinning with the concave base extends in particular around an axis of curvature which is perpendicular to both the longitudinal axis and the radial direction. The third curvature is preferably perpendicular to both the first curvature and the second curvature. The third curvature and correspondingly also the point thinning have a third radius of curvature, which in particular indicates the concavity radius of the point thinning, i.e. how the base is shaped and dimensioned. The third radius of curvature in particular also indicates a radius that forms the outer surface of the grinding wheel. In one suitable configuration, the third radius of curvature is between 5% and 60% of a diameter of the drill tip.

In a particularly advantageous design, the outer surface of the grinding wheel is formed by the aforementioned radius, which is a first radius, as well as by two straight lines and a further, i.e. second, radius. The first radius connects the two straight lines that in a sense represent radially outward-facing flanks of the grinding wheel, and the second radius forms a rounded transition of one of the straight lines to a lateral surface of the grinding wheel, wherein the lateral surface extends in particular perpendicular to the axis of rotation. The grinding wheel is not necessarily symmetrical with respect to a plane perpendicular to the axis of rotation.

In a preferred configuration, the point thinning adjoins a free surface and together with said free surface forms an edge which, starting at the chisel edge, extends in an S-shaped manner within the center. Such a characteristic S-shaped edge results in particular when the point thinning is produced using a specific grinding path for the grinding wheel. Moving the grinding wheel far into the center creates a first edge radius, which starts at the transition point between the chisel edge and the inner portion and is in particular the result of an outwardly curved grinding wheel having a convex grinding surface. This first edge radius in particular also defines the above-described base of the point thinning and forms a transition from the base to the free surface. The first edge radius is outwardly adjoined by a second edge radius, whereby said second edge radius has opposite curvature, however, so that an overall S-shape results. Both edge radii are located inside the center. To the outside, the second edge radius in particular transitions into a straight line that preferably extends all the way to the outer surface. The edge radii can in principle be the same size, but it is useful for the two radii to be different. In one suitable configuration, the first, i.e. the inner, edge radius is larger than the second, i.e. the outer, edge radius when viewed from the front; preferably by a factor of 1.1 to 5. Conversely, a configuration is also suitable in which the first, inner edge radius is smaller than the second, outer edge radius, whereby the outer edge radius is preferably larger by a factor of 1.1 to 5.

In one preferred configuration, the point thinning has a fourth curvature such that the point thinning slopes downward when viewed in radial direction and toward the outer surface. The point thinning is thus convex in radial direction and then slopes toward the back when viewed from the inside to the outside. During production, this is achieved in particular by moving the grinding wheel into the drill tip from the outer surface in the direction of the center in an arcuate manner, so that the point thinning is convex in radial direction. This at the same time also in particular produces the above-described edge to the free surface.

Overall, a plurality of suitable configurations result from the fact that, in addition to the first curvature, the curved point thinning has a second curvature, a third curvature, or a fourth curvature, or a combination thereof. A convex course, i.e. a second curvature, results in a bulbous configuration of the point thinning in the region between the free surface and the flute. In other words: the point thinning is outwardly curved, counter to the direction of rotation, i.e. backwards when viewed from the leading main cutting edge, and in the direction of the workpiece. The convex course advantageously eliminates an edge in the transition region from the point thinning to the flute, and instead produces a continuous transition which leads to improved chip removal. On the other hand, when viewed toward the center, the first axial curvature, i.e. the curved course, causes the rake angle of the main cutting edge in this region to correspondingly be increased in comparison to a configuration without such a point thinning. Similar to the first curvature, the fourth curvature leads to a bulbous configuration, albeit in a direction approximately perpendicular to the first curvature; i.e. not in the direction of rotation, but rather from the inside to the outside in radial direction. The third curvature lastly differs from the first, second and fourth curvature in that it affects a rather smaller section of the point thinning, namely the base, which is disposed in the center near the chisel edge and which in particular undercuts the inner portion and thereby in particular here also defines the rake angle.

In one suitable configuration, the drill tip comprises an outer surface, which is located radially on the outside, and the point thinning connects a flute and a free surface and extends to the outer surface, so that the free surface is completely spaced apart from the flute by the point thinning, in particular when viewed in clockwise direction, i.e. opposite to the direction of rotation, and starting from the main cutting edge. In other words: the point thinning extends to the outer edge of the drill tip, i.e. to its radially outer outer surface, so that, when viewed in clockwise direction starting from the main cutting edge, the free surface is completely spaced apart from the flute by the point thinning and the flute and the free surface are then accordingly not directly adjacent to one another. In counterclockwise direction, i.e. in the direction of rotation, the free surface adjoins the main cutting edge and then transitions into a different flute and a different point thinning.

The point thinning allows the rake angle to be optimally adjusted in the center along the main cutting edge. Due to the curved course of the point thinning, material is removed from the flute during the production of the drill tip, so that the rake angle in the region of the main cutting edge is increased.

The inner portion of the main cutting edge and the chisel edge meet at a transition point at which the point thinning accordingly also meets the free surface that laterally adjoins the chisel edge. In one suitable configuration, the rake angle at the transition point from the main cutting edge to the chisel edge changes in a non-continuous manner, i.e. discontinuously or abruptly. At the transition point there is therefore in particular a corner, which connects the inner portion to the chisel edge. Between the free surface and the point thinning there is therefore correspondingly in particular the above already described edge, which causes the rake angle to change abruptly. In general, the rake angle of the inner portion is defined by the point thinning, whereas the rake angle of the chisel edge is preferably defined by the free surface. The rake angle can thus advantageously be adjusted separately and independently along the chisel edge and the inner portion respectively.

The rake angle along the chisel edge is preferably smaller than along the main cutting edge. The cutting performance of the main cutting edge is then correspondingly particularly high and, at the same time, the smaller rake angle of the chisel edge leads to improved centering.

The rake angle is preferably negative along the chisel edge and thus smaller than along the main cutting edge. In a particularly preferred configuration, the rake angle is negative along the chisel edge and greater than −2°, preferably positive, along the main cutting edge. In one suitable configuration, the rake angle along the chisel edge is −20° or even more negative, i.e. is negative and at least 20° in terms of magnitude. The rake angle along the main cutting edge is suitably positive or 0° or slightly negative, i.e. greater than −2° and is, for example, −1°. This positive or substantially positive rake angle of the main cutting edge, in particular the inner portion, results in a stable center. This effect is further enhanced by the particularly short chisel edge.

The rake angle along the chisel edge preferably varies and in particular increases toward the inner portion, i.e. to the outside. This significantly improves the chip formation behavior and the centering. Along the chisel edge, i.e. in particular in the free surface, the rake angle is preferably −40° to −70°, i.e. is negative and is 40° to 70°.

Along the inner portion, the rake angle is preferably constant. This is in particular made possible by the specifically curved configuration of the point thinning, which is accordingly incorporated into the drill tip. The constant rake angle along the inner portion provides improved chip formation behavior. Along the inner portion, i.e. in the point thinning, the rake angle is preferably −10° to +10°.

The rake angle preferably varies along the outer portion and in particular decreases toward the inner portion, i.e. increases to the outside. This further improves the chip formation behavior, because more material is in particular removed toward the outside. Along the outer portion, i.e. in the flute, the rake angle is preferably 10° to 40°. The rake angle preferably varies along the outer portion in a manner similar to that along the chisel edge, i.e. in each case the rake angle increases to the outside, so that similar advantages are achieved in the two regions.

Some or all of the aforementioned configurations are preferably combined with one another in terms of their rake angle. In a particularly preferred configuration, viewed from the inside to the outside, the rake angle first increases along the chisel edge, then remains constant along the inner portion and then increases further along the outer portion. In an advantageous further development, the rake angle is negative along the chisel edge and positive along the main cutting edge. A rake angle of 0° is in particular considered to be a positive rake angle.

Along the main cutting edge a clearance angle is formed, which preferably varies along the inner portion and thereby in particular increases from the outside toward the inside. The clearance angle in particular also varies along the outer portion and here too increases from the outside toward the inside. However, the variation, i.e. the difference between a minimum and a maximum clearance angle, is preferably greater on the inner portion than on the outer portion. In the inner portion in particular, the clearance angle increases from the outside to the inside, preferably significantly, i.e. in particular by at least 10°. On the inner portion, the clearance angle preferably increases toward the chisel edge to at least 30°. For example, the clearance angle is 10° at the outer edge and 38° in the center of the chisel edge. On the inner portion, the clearance angle is expediently in the range of 4° to 50°. In an equally suitable variant, on the other hand, the clearance angle is constant along the inner portion or the outer portion or along the entire main cutting edge.

As already indicated above, in one preferred configuration, a plurality of main cutting edges are formed, each of which is followed by an adjoining free surface, wherein the chisel edge is then laterally bounded only, i.e. exclusively, by the free surfaces. The chisel edge is thus completely enclosed by the free surfaces and is connected to the point thinning only at the end in a quasi point connection. As a result, the design of the chisel edge is advantageously decoupled from the configuration of the point thinning, so that the rake angle along the chisel edge can advantageously be set, and is expediently also set, independently of the rake angle of the main cutting edge during the production of the drill tip.

The drill tip is in particular made of a metal, preferably hard metal. The drill tip is expediently formed as a single piece, i.e. in one piece or even monolithically, i.e. just not in a modular manner. In one suitable configuration, the cutting edges or parts thereof are provided with an additional coating.

The drill tip in particular has a diameter that is preferably in the range of 1 mm to 40 mm. The center diameter is preferably at least 20% of the diameter and at most 75%. The chisel edge preferably has a length of 2% to 15% of the diameter measured along a straight line connecting the end points of the chisel edge. If the inner portion is kinked in an arcuate manner, a respective straight subsection preferably has a length in the range of 1% to 20% of the diameter of the drill tip.

To produce a drill tip as described above, a point thinning is formed, which is curved in such a way that the inner portion extends arcuately from an outer edge of the center toward the chisel edge. The advantages result accordingly.

During production, a grinding wheel is in particular used, which is guided along a grinding path and removes material from the center of the drill tip. As a result, in particular a cutting corner originally formed by the chisel edge and the main cutting edge is ground off and replaced with the curved inner portion. The formation of the point thinning advantageously also shortens the chisel edge.

In a particularly preferred configuration, the entire point thinning is ground in a single grinding pass and along a single and continuous grinding path. This results in particular in the advantage that the grinding wheel does not have to be taken off, but is moved in a single pass. Even though the grinding path is correspondingly complex depending on the configuration of the point thinning, overall production is particularly simple and expeditious due to the only one grinding pass for forming the point thinning.

A point thinning that is both curved and convex, results in particular in a grinding path that follows a double-curved course. The grinding path then has two curves, which are traversed one after the other and are curved in different planes. To produce the curved point thinning, i.e. the curvature that forms the inner portion, the grinding wheel is expediently tilted or inclined perpendicular to an axis of rotation of the grinding wheel. To produce the convex point thinning, i.e. the curvature via which a flute transitions into a free surface in an arcuate manner, on the other hand, the grinding wheel is expediently, so to speak, rolled over its grinding surface. These two movements are suitably carried out in a superimposed manner or successively, i.e. one after the other.

The object is in particular also achieved by a drill having a drill tip as described above, as well as by a separate drill tip which is configured as an insert for a carrier and which when connected to said carrier forms a modular drill. The object is in particular also achieved by a grinding wheel for producing a drill tip as described. All statements regarding the drill tip and the method apply analogously to the drill and the grinding wheel.

### DESCRIPTION OF THE FIGURES

Design examples of the invention are explained in more detail in the following with the aid of a drawing. The figures show schematically:

FIG. 1 a drill tip of a drill in a front view,

FIG. 2 the drill of FIG. 1 in a side view,

FIG. 3 an enlarged section of the drill tip of FIG. 1,

FIG. 4 a perspective view of the drill trip of FIG. 1,

FIG. 5 a variant of the drill tip in a front view,

FIG. 6 a perspective view of the drill trip of FIG. 5,

FIG. 7 a further perspective view of the drill trip of FIG. 5,

FIG. 8 the drill trip of FIG. 5 in a side view,

FIG. 9 the drill trip of FIG. 5 in a further side view,

FIG. 10 the drill trip of FIG. 5 in a further side view,

FIG. 11 a further variant of the drill tip in a front view,

FIG. 12 a perspective view of the drill trip of FIG. 11,

FIG. 13 the drill trip of FIG. 11 in a side view,

FIG. 14 a detail of a grinding wheel in a sectional view,

FIG. 15 the grinding wheel of FIG. 14 during the production of a drill tip,

FIG. 16 a further variant of the drill tip in a front view,

FIG. 17 an enlarged detail of FIG. 16,

FIG. 18 the drill tip of FIG. 16 in a side view,

FIG. 19 the drill tip of FIG. 16 in a perspective view,

FIG. 20 the drill tip of FIG. 16 in a different perspective view,

FIG. 21 a sectional view of the view of FIG. 20.

### DESCRIPTION OF THE DESIGN EXAMPLES

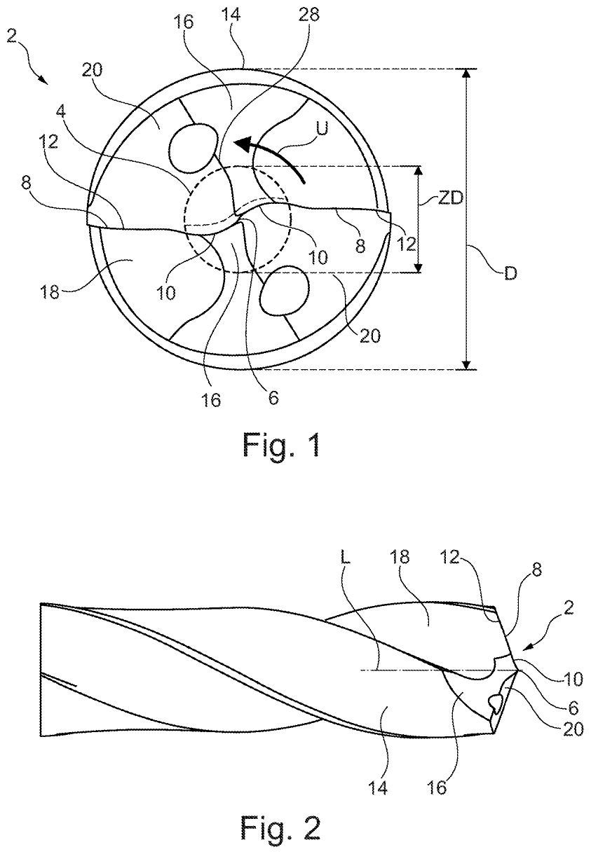

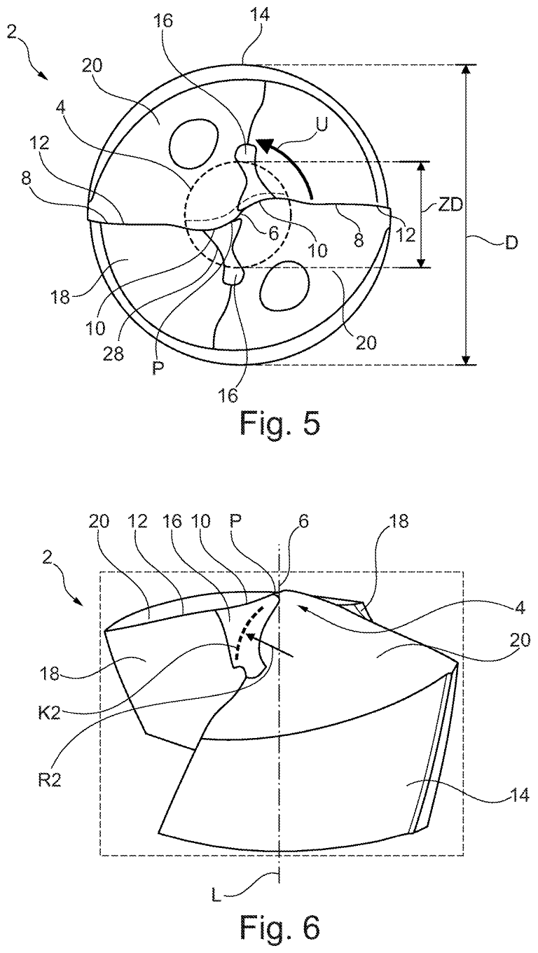

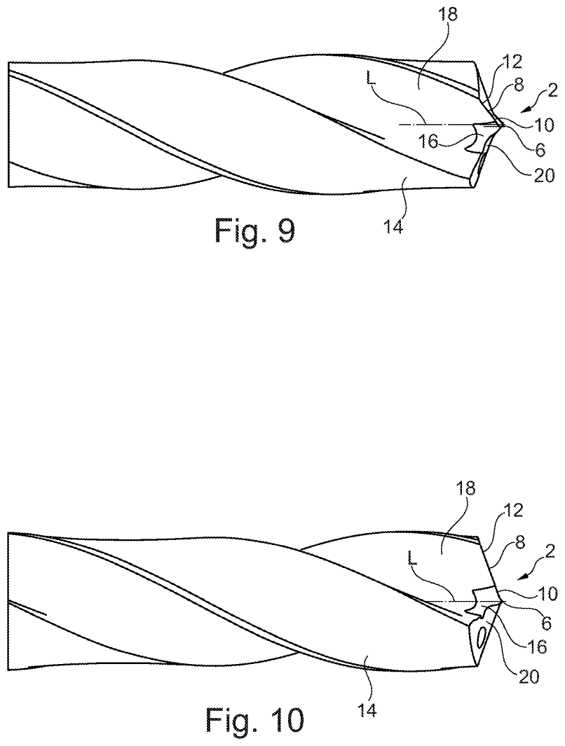

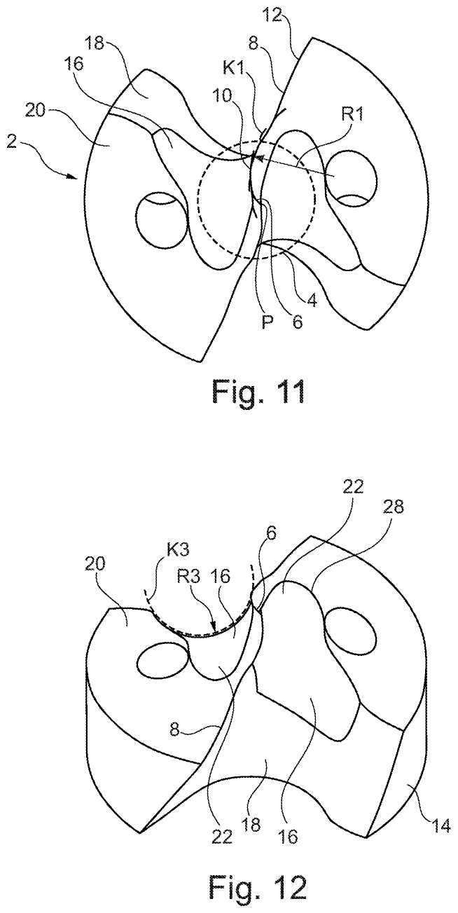

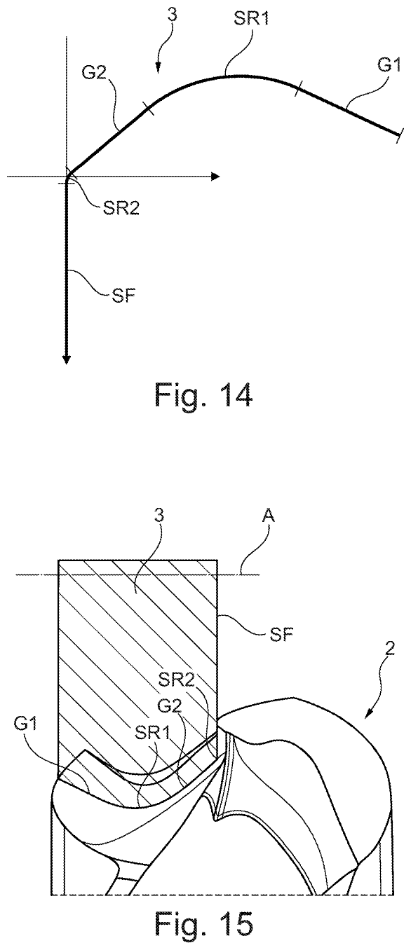

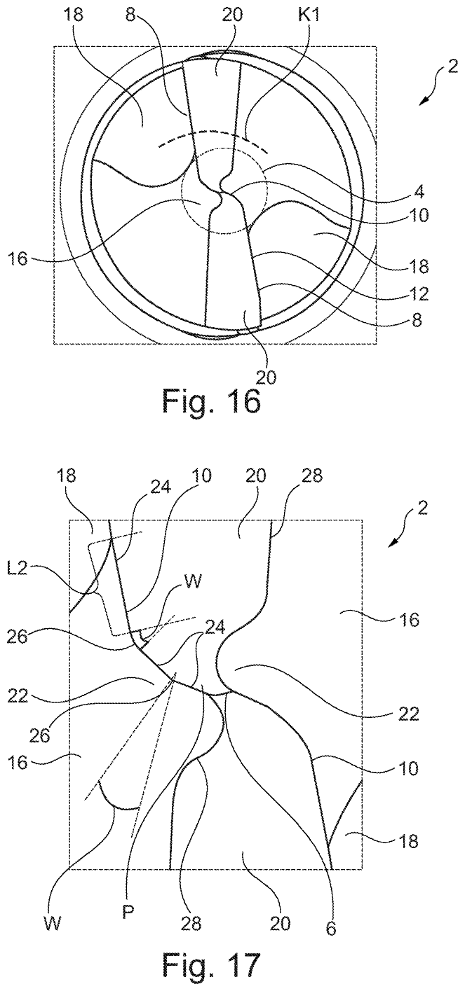

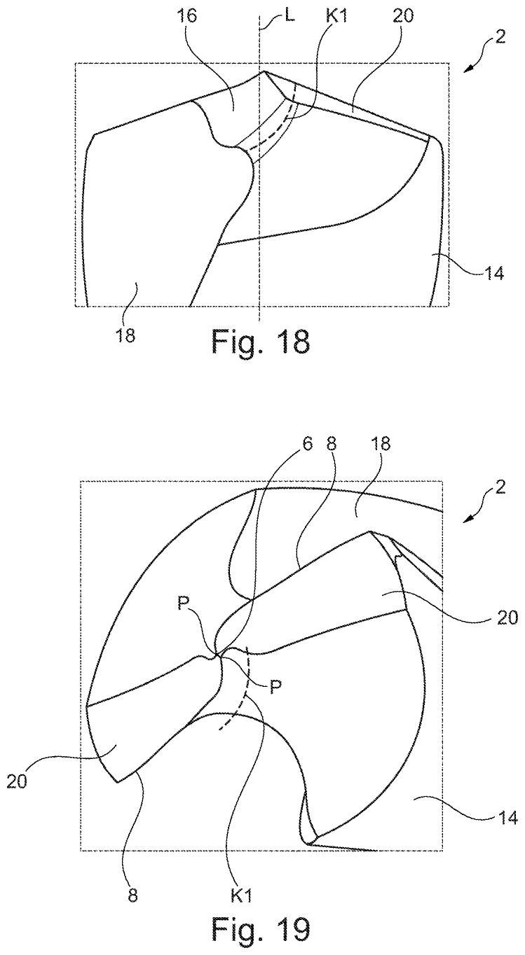

The figures show various design examples of a drill tip 2, which is a part of a drill that is shown only in sections. FIGS. 1 to 4 show a first variant of the drill tip 2, FIGS. 5 to 10 show a second variant and FIGS. 11 to 13 show a third variant. FIG. 14 then shows a particularly advantageous grinding wheel 3 for producing the drill tip 2, and FIG. 15 shows such a production. Lastly, FIGS. 16 to 21 show a fourth variant of the drill tip 2. The drill tip 2 here is an integral component of a drill and as such is monolithically connected to a shank. In a not depicted variant, on the other hand, the drill tip 2 is a separate part and is then configured as an insert that can be inserted into a carrier, so that the carrier and the drill tip 2 together form a modular drill. During operation, the drill tip 2 rotates in a direction of rotation U around an axis of rotation L, which is also an axis of rotation of the drill as a whole and which also corresponds to a longitudinal axis of the drill tip 2 and the drill as a whole and generally extends in a longitudinal direction.

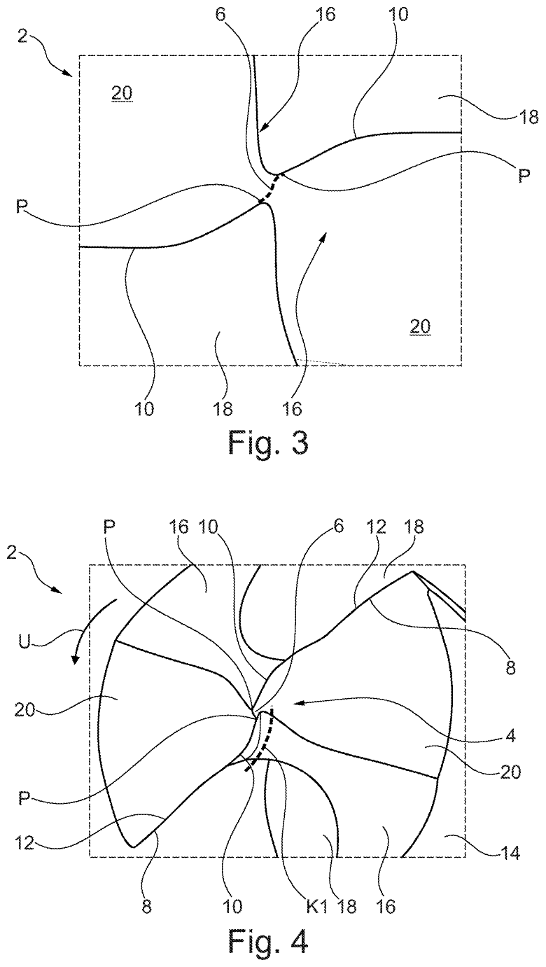

The drill tip 2 comprises a center 4, in which a chisel edge 6 is disposed. In FIG. 1, the center is indicated with a dashed circle. When viewing the drill tip 2 from the front along the axis of rotation L, the center 4 is correspondingly located in the center, as can be seen in FIG. 1. In FIG. 2, the drill and the drill tip of FIG. 1 are shown from the side. FIG. 3 shows an enlarged view of the center 4. FIG. 4 shows a perspective view of the drill and specifically the drill tip 2.

The drill tip 2 comprises a number of main cutting edges 8, in this case two, each of which adjoins the chisel edge 6 and extends outward from the center 4. In a not depicted variant, the drill tip 2 has a different number of main cutting edges 8. The main cutting edges 8 and the chisel edge 6 are respectively also referred to in short simply as the cutting edge and overall together form a cutting geometry of the drill tip 2.

A respective main cutting edge 8 here is divided into two sections, namely an inner portion 10 which adjoins the chisel edge 6 and is disposed inside the center 4, and an outer portion 12 which adjoins the inner portion 10 to the outside and is disposed outside the center 4. The transition from the inner portion 10 to the outer portion 12 thus defines the center 4 of the drill tip 2, so that the inner portion 10 is on the inside and the outer portion 12 is on the outside. The outer portion 12 then extends outward to an outer surface 14 of the drill tip 2.

Each of the cutting edges 6, 8 is adjoined by a surface which points in the direction of rotation U and via which any produced chips are removed. The orientation of this surface relative to a workpiece is characterized by the so-called rake angle, which, depending on the configuration, can in principle also assume different values at different locations along the cutting edges 6, 8.

The rake angle is now modified in the center 4 by a specific point thinning 16. The point thinning 16 is disposed in the center 4 and is initially used to shorten the chisel edge 6, i.e. is ground in on the front during production to shorten the chisel edge 6. The point thinning 16 is furthermore curved in such a way that the inner portion 10 extends arcuately from an outer edge of the center 4 toward the chisel edge 6. Two variants are possible. In a first variant, the inner portion 10 is continuously arcuate; this is the case in the design examples of FIGS. 1 to 13. In a second variant, on the other hand, the inner portion 10 is kinked in an arcuate manner, as shown in the design example of FIGS. 16 to 21.

The outer edge and the center 4 are indicated in FIG. 1 with a dashed circle. The point thinning 16 is generally a curved point thinning 16, i.e. it comprises a first curvature K1, which is configured such that the point thinning 16 curves axially, i.e. quasi in the direction of rotation U. The first curvature K1 is explicitly indicated in FIGS. 4, 7, 16, 18 and 19 with a curved, dashed line. It is also evident that the first curvature K1 and thus the point thinning 16 have a first radius of curvature R1, which in particular indicates the radius with which the point thinning 16 is curved. In FIG. 4, the first radius of curvature R1 also corresponds to the radius of the inner portion 10.

The described first curvature K1 of the point thinning 16 automatically results in an arcuate course of the main cutting edge 8 in the center 4, so that the inner portion 10 is also formed when the point thinning 16 is formed. The arcuate course of the main cutting edge 8 allows said main cutting edge to be taken particularly far into the center 4 and the chisel edge 6 to be shortened as already mentioned. The main cutting edge 8 is correspondingly lengthened.

In a leading position, i.e. in the direction of rotation U in front of a respective main cutting edge 8, a respective flute 18 is formed, which adjoins the associated main cutting edge 8. The flute 18 is used to convey a chip that is removed by the main cutting edge 8. On the other side of the main cutting edge 8, i.e. opposite to the flute 18 and in the direction of rotation U behind the main cutting edge 8, a free surface 20 is configured which generally faces toward the front. For each main cutting edge 8 of the drill tip 2, a flute 18 and free surface 20 are now configured, which surround the respective main cutting edge 8 accordingly.

The two main cutting edges 8 shown in the respective design example each have an arcuate inner portion 10, which are S-shaped when viewed together. This is specifically emphasized in FIG. 1 with a dashed and S-shaped line, which is drawn slightly offset for better visibility. However, the S-shaped can also be seen directly in FIGS. 3 to 6, 11, 12, 16 and 17. The inner portions 10 are thus all curved in the same direction and together extend toward the chisel edge 6. The chisel edge 6 is then disposed in the center of the S-shaped course.

In the design examples shown, the chisel edge 6 itself is also S-shaped. For this purpose, the chisel edge 6 is correspondingly enclosed by twisted free surfaces 20, so that an S-shaped course results. This is particularly evident in the detail views in FIGS. 3 and 17, whereby a dashed and S-shaped line is additionally included in FIG. 3 to illustrate the S-shaped course. The S-shape of the chisel edge 6 is not mandatory, however; the chisel edge 6 can also have other geometries.

A respective free surface 20 is bounded toward the front by a main cutting edge 8 and toward the rear by a point thinning 16 or a flute 18 and a point thinning 16. To the outside, a respective free surface 20 is bounded by the outer surface 14 of the drill tip 2. In the center 4, on the other hand, a respective free surface 20 is bounded by the chisel edge 6. The free surfaces 20 are now preferably twisted such that an S-shaped chisel edge 6 results. In the present case, the chisel edge 6 is laterally bounded only by the free surfaces 20. Only the end points of the chisel edge 6, i.e. the transition points P to the main cutting edges 8, abut a respective point thinning 16, so that the chisel edge 6 extends between the two opposite point thinnings 16. The chisel edge 6 is thus completely enclosed by the free surfaces 20 and only at the end is in a quasi point connection with the point thinning 16. In a not depicted variant, on the other hand, the chisel edge 6 is not S-shaped.

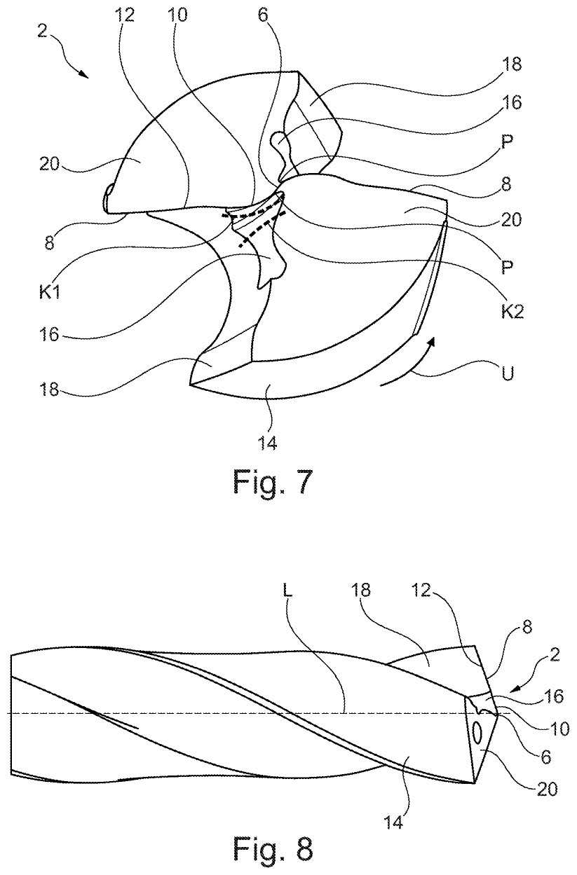

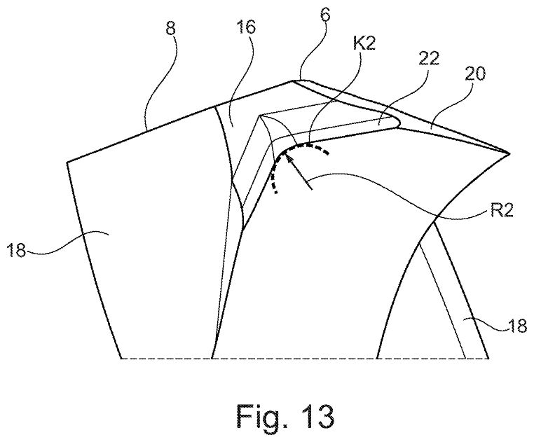

In the variants shown in FIGS. 1 to 4, the point thinning 16 is merely curved as indicated in FIG. 4. In the variants of FIGS. 5 to 13 and 16 to 21, however, the point thinning 16 is additionally convex such that it extends from one of the flutes 18 and in the direction of one of the free surfaces 20 in an outwardly curved manner. In addition to the axial, first curvature K1 of the point thinning 16, said point thinning is also radially curved; i.e. in addition to the first curvature K1 it has a second curvature K2, which is then a radial curvature K2. This additional second curvature K2 is explicitly indicated in the perspective illustrations in FIGS. 6 and 7 with a dashed curve K2 and is also clearly visible in the sectional view of FIG. 13. The second curvature K2 and the point thinning 16 thus have a second radius of curvature R2, which indicates the radius with which the point thinning 16 is curved and the radius with which the point thinning 16 transitions from the flute 18 into the free surface 20.

The first curvature K1 is not explicitly indicated in FIG. 6, but is nonetheless present and is explicitly shown in the perspective view of FIG. 7 in addition to the second curvature K2. The point thinning 16 is thus curved and connects the flute 18 of one of the main cutting edges 8 to the free surface 20 of the corresponding leading main cutting edge 8. In addition to the first, axial curvature K1 of the point thinning 16, said point thinning is thus also radially curved by the second curvature K2. Overall, therefore, the point thinning 16 is a curved and convex point thinning 16. The convex course results in a bulbous configuration of the point thinning 16 in the region between the free surface 20 and the flute 18. This can be seen particularly clearly in FIG. 7. FIGS. 8 to 10 further show respective side views of the drill with the drill tip 2 of FIG. 5, whereby the specific geometry of the point thinning 16 is evident in these side views as well. The point thinning 16 is curved outward and counter to the direction of rotation U, i.e. backwards when viewed from the leading main cutting edge 8, and in the direction of the not depicted workpiece.

The convex course advantageously eliminates an edge in the transition region from the point thinning 16 to the flute 18 and, as shown here, instead produces a continuous transition. The first, axial curvature K1, on the other hand, when viewed toward the center 4, results in the rake angle of the main cutting edge 8 being correspondingly increased.

FIGS. 11 to 13 show a further configuration, in which the point thinning 16 comprises a base 22 that is concave when viewed in radial direction. This can be seen particularly clearly in the perspective view in FIG. 12. The concave base 22 is created during the production of the drill tip 2 using a convex, i.e. outwardly curved, grinding wheel 3. Such a grinding wheel 3 has a grinding surface which faces radially outward with respect to an axis of rotation A of the grinding wheel 3 and is convex in cross-section perpendicular to the axis of rotation A. The point thinning 16 is then curved inward, i.e. in the direction of a rear side of the drill tip 2 and into said drill tip.

The point thinning 16 with the concave base 22 thus has a third curvature K3, which is specifically shown in FIG. 12 with a dashed line. The third curvature K3 and the point thinning 16 then have a third radius of curvature R3, which indicates the radius with which the base 22 is concave and the radius of the outer surface of the grinding wheel 3. The first curvature K1 is then explicitly indicated in FIG. 11 with a dashed line. The second curvature K2 is indicated in FIG. 13 with a dashed line. FIGS. 11 to 13 each also show the associated radii of curvature R1, R2, R3.

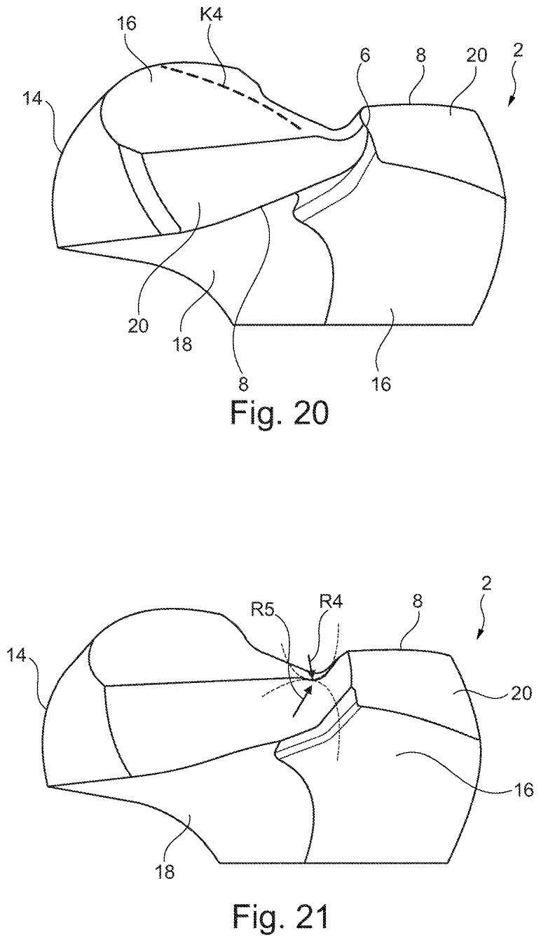

The design example of FIG. 20 shows a fourth curvature K4 which, like the first curvature K1, results in a convex point thinning 16, not in the direction of rotation U, however, but rather when viewed in radial direction from the inside to the outside, so that the point thinning 16 slopes downward from the center 4 toward the outer surface 14.

It can clearly be seen in FIGS. 11 to 13 that the convex point thinning 16 with the concave base 22 has a saddle-shaped course and is therefore configured as a saddle surface between the flute 18 and the free surface 20. Due to the first curvature K1, the saddle surface is also curved in the direction of rotation U.

Overall it is evident that different configurations of the drill tip 2 result from the fact that, in addition to the first curvature K1, the curved point thinning 16 has a second curvature K2, a third curvature K3, a fourth curvature K4 or any combination thereof. A convex course, i.e. a second curvature K2, K4, results in a bulbous configuration of the point thinning 16 in the region between the free surface 18 and the flute 20 as can be seen in FIGS. 6, 13 and 20, for example. A third curvature K3 results in a base 22, which also defines the rake angle and, if necessary, undercuts the inner portion 10 accordingly.

In the present case, in FIGS. 1 to 4 and 16 to 21, the point thinning 16 extends to the outer edge of the drill tip 2, i.e. to its radially outer outer surface 14, so that, when viewed in clockwise direction, i.e. counter to the direction of rotation U, starting from the main cutting edge, the free surface 20 is completely spaced apart from the flute 18 by the point thinning 16 and the flute 18 and the free surface 20 are then not adjacent to one another. In FIGS. 5 to 13, on the other hand, the point thinning 16 is not continuous to the outer surface 14, but here is continuous only to half the radius, i.e. a quarter of the diameter D of the drill tip 2. The configuration of the point thinning 16 to the outer surface 14 is independent of whether the point thinning has one or more further curvatures K2, K3, K4 in addition to the first curvature K1. The concepts for the curvatures K1-K4 described in connection with the individual variants of the drill tip 2 can be combined with one another as desired and also with a point thinning 16 extending to the outer surface 14.

As can be seen in particular in FIGS. 4 to 7, 11 and 17, the inner portion 10 of the main cutting edge 8 and the chisel edge 6 meet at a transition point P at which the point thinning 16 accordingly also meets the free surface 20 that laterally adjoins chisel edge 6. At the transition point P, the rake angle changes from the main cutting edge 8 to the chisel edge 6 in a non-continuous, i.e. abrupt manner. At the transition point P there is therefore a corner, which connects the inner portion 10 to the chisel edge 6. Between the free surface 20 and the point thinning 16 there is correspondingly an edge, which causes the rake angle S to change abruptly. As a matter of principle, the edge generally ends where the inner portion 10 transitions into the outer portion 12. The rake angle of the inner portion 10 is thus defined by the point thinning 16, whereas the rake angle of the chisel edge 6 is defined by the free surface 20.

In the design example of FIGS. 16 to 21, the inner portion 10 is kinked in an arcuate manner and comprises a plurality of straight subsections 24, which are disposed at an angle to one another. In the present case there are exactly three straight subsections 24. The subsections 24 are disposed roughly along an arc, which results in an overall arcuate course. When viewed toward the free surface 20, two consecutive subsections 24 enclose an angle W, which is smaller than 180° and in one case here is approximately 155° and 145°, whereby the further inward angle W is greater than the further outward angle W.

Two consecutive straight subsections 24 are connected to one another via a rounded corner 26 such that a continuously arcuate transition is formed between two subsections 24. The overall twice-kinked course can be seen particularly well in the detail view of FIG. 17. As can further be seen in FIG. 17, the outermost subsection 24 in the present case transitions into the outer portion 12 of the main cutting edge 8 in a straight manner, so that there is no kink at the transition from the inner portion 10 to the outer portion 12. The straight subsections 24 also each have a length L2 which increases here when viewed from the inside to the outside, so that a further outward subsection 24 is longer than a further inward subsection 24.

The point thinning 16 generally adjoins a free surface 20 and, specifically in the design examples shown, forms an edge 28 with said free surface. In the design example of FIGS. 16 to 21, the edge 28 characteristically extends in an S-shape starting at the chisel edge 6 and inside the center 4. Starting at the transition point P between the chisel edge 6 and the inner portion 10, a first edge radius R4 is formed, which forms a transition from the base 22 of the point thinning 16 to the free surface 20. This can be seen particularly well in FIG. 17 and in the perspective view in FIG. 20. The first edge radius R4 is outwardly adjoined by a second edge radius R5, whereby said second edge radius has opposite curvature, however, so that an overall S-shape results. Both edge radii R4, R5 are located inside the center 4. To the outside, as can be seen in FIG. 20, for example, the second edge radius R5 transitions into a straight line which, in the shown design example, extends to the outer surface 14. In the present case, when viewed from the front, the first, i.e. the inner, edge radius R4 is greater than the second, i.e. the outer, edge radius R5.

FIG. 21 shows the same view as FIG. 20, but with a section from the point thinning 16 to the flute 18, so that the free surface 20 is not visible, but the two edge radii R4, R5 which are emphasized by additional circles are. On the other hand, in the sectional view, and thus without considering the free surfaces 20, the inner edge radius R4 is smaller than the outer edge radius R5 as shown in FIG. 21.

In the design examples shown, the rake angle is negative along the chisel edge 6 and positive along the main cutting edge 8 and is thus smaller along the chisel edge 6 than along the main cutting edge 8. The rake angle varies along the chisel edge 6 and increases toward the inner portion 10. On the other hand, the rake angle along the inner portion 10 here is constant, i.e. keeps the same value. This is accomplished by the specific curved configuration of the point thinning 16. The rake angle varies again along the outer portion 12 and, as with the chisel edge 6, increases to the outside. The free surface 20, which follows a respective main cutting edge 8, forms a clearance angle which here varies along the outer portion 12 and in particular also along the inner portion 10 and thereby increases to the inside.

The drill tip 2 has a diameter D, which is in the range of 1 mm to 40 mm and is 8.5 mm in the design examples. The center 4 has a center diameter ZD, which is 20% to 75% of the diameter D. In the design examples, the center diameter CD is in the range of 2 mm to 4 mm. The chisel edge 6 has a length of 0.5% to 15% of the diameter D and in the design examples is between 0.17 mm and 1.27 mm, measured along a not depicted straight line which connects the end points of the chisel edge 6, i.e. the transition points P.

During production of the drill tip 2, a grinding wheel 3 is used, which is guided along a grinding path and removes material from the center 4. As a result, a cutting corner originally formed by the chisel edge 6 and the main cutting edge 8 is ground off and replaced with the curved inner portion 10 and the chisel edge 6 is shortened at the same time. A design example for a grinding wheel 3 is shown in FIG. 14; the use of this grinding wheel 3 for producing a drill tip 2 is shown in FIG. 15. The entire point thinning 16 is ground in a single grinding pass and along a single and continuous grinding path. In the case of the point thinning 16 that is both curved and convex shown in FIGS. 5 to 13, the result is a grinding path which follows a multiple curved course, so that the correspondingly formed curvatures K1, K2, K3 are carried out in a superimposed manner or successively. The grinding path is then a superposition of the curvatures K1, K2, K3, which are traversed successively or in a superimposed manner, i.e. simultaneously or partially simultaneously, and which are curved in different planes. To produce the curved point thinning 16, i.e. the first curvature K1 that forms the inner portion 10, the grinding wheel 3 is tilted or inclined perpendicular to an axis of rotation A of the grinding wheel 3. To produce the convex point thinning 16, i.e. the second curvature K2 via which a flute 18 transitions into a free surface 20 in an arcuate manner, on the other hand, the grinding wheel 3 is rolled over its grinding surface. The third curvature results automatically from the grinding contour of the grinding wheel 3. This grinding contour becomes particularly clear with the example in FIG. 14. The grinding wheel 3 shown there comprises an outer surface, which is generally formed by a first radius SR1, by two straight lines G1, G2, and a further, i.e. second, radius SR2. The first radius SR1 connects the two straight lines G1, G2 that in a sense represent radially outward-facing flanks of the grinding wheel 3, and the second radius SR2 forms a rounded transition of the straight line G2 to a lateral surface SF of the grinding wheel 3, wherein the lateral surface SF here extends perpendicular to the axis of rotation. FIG. 15 in particular shows that the grinding wheel 3 is not necessarily symmetrical. It is also evident that the first radius SR1 in this case corresponds to the third radius of curvature R3.

1. A drill tip, comprising:
a center, in which a chisel edge is disposed; and
a main cutting edge, which adjoins the chisel edge and extends outward from the center,
wherein a rake angle is formed along the chisel edge and the main cutting edge,
wherein the main cutting edge comprises an inner portion, which adjoins the chisel edge and which is disposed inside the center,
wherein the main cutting edge comprises an outer portion, which adjoins the inner portion to the outside and which is disposed outside the center, wherein a point thinning is formed, which is curved in such a way that the inner portion extends arcuately from an outer edge of the center toward the chisel edge.

2. The drill tip according to claim 1, wherein the inner portion is continuously curved and extends from the outer edge to the chisel edge in a continuously arcuate manner.

3. The drill tip according to claim 1, wherein the inner portion is shaped in an arcuate manner and comprises a plurality of straight subsections, which are disposed at an angle to one another.

4. The drill tip according to claim 3, wherein the inner portion comprises at least three straight subsections.

5. The drill tip according to claim 4, wherein two consecutive straight subsections are connected to one another via a rounded corner.

6. The drill tip according to claim 1, wherein at least two main cutting edges are formed, each comprising an arcuate inner portion, wherein the two inner portions are S-shaped when viewed together.

7. The drill tip according to claim 1, wherein the chisel edge is bordered by a plurality of free surfaces, which are configured such that the chisel edge extends in an S-shaped manner.

8. The drill tip according to claim 1, wherein the point thinning connects a flute and a free surface and is additionally convex such that the point thinning extends from the flute in the direction of the free surface in an outwardly curved manner.

9. The drill tip according to claim 1, wherein the point thinning comprises a base, which is concave when viewed in radial direction.

10. The drill tip according to claim 1, wherein the point thinning adjoins a free surface and together with said free surface forms an edge which, starting at the chisel edge, extends in an S-shaped manner within the center.

11. The drill tip according to claim 1, wherein said drill tip comprises an outer surface, which is located radially on the outside, and
wherein the point thinning connects a flute and a free surface and extends to the outer surface, so that the free surface is completely spaced apart from the flute by the point thinning.

12. The drill tip according to claim 1, wherein the rake angle at a transition point (P) from the main cutting edge to the chisel edge changes in a non-continuous manner.

13. The drill tip according to claim 1, wherein the rake angle along the chisel edge is smaller than along the main cutting edge.

14. The drill tip according to claim 1, wherein the rake angle is negative along the chisel edge and greater than −2° and in particular positive along the main cutting edge.

15. The drill tip according to claim 1, wherein the rake angle varies along the chisel edge and increases toward the inner portion.

16. The drill tip according to claim 1, wherein the rake angle along the inner portion is constant.

17. The drill tip according to claim 1, wherein the rake angle along the outer portion varies and decreases toward the inner portion.

18. The drill tip according to claim 1, wherein a clearance angle is formed along the main cutting edge, which varies along the inner portion.

19. The drill tip according to claim 1, wherein a plurality of main cutting edges are formed, each of which is followed by an adjoining free surface, and wherein the chisel edge is laterally bounded only by the free surfaces.

20. A method for producing a drill tip according to claim 1, wherein a point thinning is formed, which is curved in such a way that the inner portion extends arcuately from an outer edge of the center toward the chisel edge.

21. The method according to claim 20, wherein the entire point thinning is ground in a single grinding pass and along a single and continuous grinding path.
